(19) United States
(12) Patent Application Publication
(10) Pub. No.: US 2026/0135019 A1
(43) Pub. Date: May 14, 2026

(54) COAXIAL LINE WITH INCREASED BANDWIDTH

(71) Applicant: SPINNER GmbH, München (DE)

(72) Inventors: Hans-Ulrich Nickel, Neubiberg (DE); Janno Zovo, München (DE); Andreas Grabichler, Bruckmühl (DE); Christian Kolb, Bad Feilnbach (DE); Katharina Schäpers, Kolbermoor (DE)

(21) Appl. No.: 19/444,431

(22) Filed: Jan. 9, 2026

Related U.S. Application Data
(63) Continuation of application No. PCT/EP2024/066744, filed on Jun. 17, 2024.

(30) Foreign Application Priority Data
Jul. 11, 2023 (EP) 23184598.3

(51) Int. Cl. H01B 11/18

(52) U.S. Cl. CPC H01B 11/1808; H01B 11/186

(57) ABSTRACT

A coaxial line with a circular inner conductor and a coaxially arranged circular outer conductor has multiple coaxial supports. Each support includes a body having an inner insulating section with an inner bore for the inner conductor and an outer conductive section radially around the inner insulating section. The outer conductive section is electrically connected to the outer conductor.

### FIELD OF THE INVENTION

The invention relates to a coaxial line for transmission of RF signals with increased bandwidth and supports for a coaxial line having increased bandwidth.

### Description of the Related Art

A coaxial line having a cylindrical inner conductor and a hollow cylindrical outer conductor, both of conductive materials is disclosed in U.S. Pat. No. 3,249,901. The inner conductor and the outer conductor are spaced to form an annual gap by supports also called spacers of a dielectric material. A spiral groove is provided to reduce reflections.

Such coaxial lines normally are used to transfer signals in a TEM (Transverse Electromagnetic Mode). Within the cylindrical outer conductor of the coaxial line, other unwanted modes may propagate. Other modes than TEM may result in dispersion and a higher attenuation of a signal.

The TE11 mode is the mode with the lowest cutoff frequency in a cylindrical waveguide, which corresponds to the outer conductor of the coaxial line. The cutoff frequency of a mode is the lowest frequency at which the mode may persist. For the TE11 mode this cutoff frequency is inverse proportional to the diameter of the conductors of the coaxial line. For frequencies above the cutoff frequency, a TEM wave traveling through the line may at least partially convert to TE11 mode. Normally, a coaxial line will be usable in TEM mode up to frequencies reaching 90% of the TE11 cutoff frequency, such that a TE11 mode still cannot persist.

### SUMMARY OF THE INVENTION

The problem to be solved by the invention is to provide improved coaxial lines, such that they can be used for higher frequencies which are closer than 90% or more at the cutoff frequency of the TE11 mode given by the outer conductor diameter of the coaxial line. Further, supports for coaxial lines having increased bandwidth may be provided. Another aspect is to provide a solution which can be manufactured down to very small geometries of conductors for the millimeter wave range.

Solutions of the problem are described in the independent claims. The dependent claims relate to further improvements of the invention.

The embodiments relate to coaxial line supports and/or coaxial lines having coaxial line supports. A coaxial line support may have an inner bore at a center axis and an outer circular contour symmetrically to the center axis. It may basically have the shape of a disk. Its diameter may be larger than its thickness. The coaxial line support has an inner insulating section at the inner bore and an outer conductive section radially around the inner insulating section. The inner bore may be configured for holding an inner conductor of a coaxial line and the outer circular contour may be configured to be held at the inner side of an outer conductor of the coaxial line. The coaxial line support may be configured for holding an inner conductor of a coaxial line centered within the coaxial line. The coaxial line support may be rotational symmetric around the center axis. The outer circular contour may further be configured to electrically contact more than 10%, more than 40% or more than 60% of its outer surface the outer conductor of the coaxial line.

A coaxial line may have a circular cylindrical inner conductor centered within a hollow circulary cylindrical outer conductor. There may be an airgap between the inner conductor and the outer conductor. The coaxial line may include at least one coaxial line support as disclosed herein. At least one coaxial line support may be arranged between the inner conductor and the outer conductor, while at least mechanically contacting the inner conductor and the outer conductor. Therefore, the coaxial line support may hold the inner conductor at a fixed position within the outer conductor. The inner conductor is uninterrupted, e.g., it has no gap or interruption within the coaxial line support except mating gaps at its outer contour. Its outer contour may vary. The outer circular contour of the coaxial line supports may further be configured to electrically contact more than 10%, more than 40% or more than 60% of its outer surface the outer conductor of the coaxial line.

The concept of the coaxial lines and coaxial line supports is based on restricting the inner diameter of the outer conductor such that the cut-off frequency of the line, which normally is defined by the inner diameter of the outer conductor (D) and the outer diameter of the inner conductor (d), is increased. The cutoff frequency may be estimated by: Fc=c/(pi/2*(D+d)). This allows to transfer signals of higher frequencies in TEM mode before they transition to TE11 mode. To achieve this, the coaxial line supports include an inner insulating section, which may include a dielectric and/or insulating material. Such a material may be a plastic material, preferably a material having low dielectric losses at high frequencies. Such materials may include PTFE, polyethylene (HD-PE) or ceramic materials. The inner insulating section is configured to be placed at an inner conductor of a coaxial line. For better axial positioning, it may be configured to be placed in a reduced diameter section of the inner conductor. Radially outside of the inner insulating section, there is an outer conductive section. The outer conductive section may include a conductive material, having low losses at high frequencies, which may include copper, gold, silver. It may include a solid body of such a conductive material or a body having a surface coating with such a conductive material. This may for example be a plastic body having a gold plated or coated surface. The advantage of plastic bodies is that they can easily be manufactured by a 3D printing process, which may be a similar process as for manufacturing the inner insulating section.

The outer conductive section may be in electrical contact with the outer conductor of the coaxial line, or it may be part of the outer conductor of the coaxial line. Anyway, it may be in good electrical contact with the outer conductor of the coaxial line.

In an embodiment, the inner diameter of the outer conductive section is smaller than the inner diameter of the outer conductor of the line. Therefore, it restricts the inner diameter to a smaller size and therefore increases the cut-off frequency or TE11 modes. This may allow to transfer higher frequencies through the coaxial line in TEM mode without transitioning to TE11 mode.

A support may also be a resonator. A radial pattern may result in modes like TEM, TE11. A longitudinal pattern has resonances, which can be attenuated by absorber material as disclosed herein. The resonances may also be moved to frequencies above the cutoff frequency.

In a further embodiment, at least one of the supports may include an electrically absorbing material. For example, the outer conductive section may include such an electrical absorbing material which may at the same time restrict the diameter of the line and would attenuate a wave propagating in higher modes like TE11.

In an embodiment, the outer conductor may have coupling holes, coupling channels or coupling slits which may be covered by electrically absorbing material. In a further embodiment, the absorbing material may even cover the whole outer conductor, i.e. creating a surrounding ring of absorbing material.

In an embodiment, at least one of the outer conductive section may include a radial metal layer. Further, an outer conductive section may include at least one coupling hole through the outer conductive section and an absorber radially outside of the at least one coupling hole. A coupling hole may be a slit or a channel.

In an embodiment, the coaxial line support may fit into the inner diameter of the outer conductor, such that it is slidable along the center axis. Further, a locking means may be provided to lock a coaxial line support to a specific position of the outer conductor. The locking means may e.g. include a locking pin, a locking screw or a locking clip. It may protrude through a locking opening in the outer conductor into a recess of the coaxial line support. A locking means, e.g. a locking clip may allow a rotation of the coaxial line support, if it interfaces with a circular groove of the coaxial line support.

The inner conductor may have a non-circular shape matching to a support and being configured to prevent relative rotation of the inner conductor with respect to the support.

The outer conductor may include at least one hole or opening configured for injecting a plastic material for locking the support mechanically and/or for injection molding a support.

The at least one coaxial line support may be a resonator having a resonance frequency above or equal to a cutoff frequency of the coaxial line. All embodiments disclosed herein may be combined in any combination.

### BRIEF DESCRIPTION OF THE DRAWINGS

In the following the invention will be described by way of example, without limitation of the general inventive concept, on examples of embodiment with reference to the drawings.

FIG. 1 shows a basic coaxial line in a sectional view.

FIG. 2 shows a first embodiment in a sectional view.

FIG. 3 shows a modified embodiment in a sectional view.

FIG. 4 shows a cross section of the first embodiment.

FIG. 5 shows a coaxial line support on a inner conductor.

FIG. 6 shows a second embodiment in a sectional view.

FIG. 7 shows a third embodiment in a sectional view.

FIG. 8 shows a fourth embodiment in a sectional view.

FIG. 9 shows a cross section of the fourth embodiment.

FIG. 10 shows a fifth embodiment in a sectional view.

FIG. 11 shows a sixth embodiment in a sectional view.

FIG. 12 shows the sixth embodiment in a further sectional view.

FIG. 13 shows a specific embodiment of an absorber section.

FIG. 14 shows a coaxial line support.

FIG. 15 shows a slidable coaxial line support.

FIG. 16 shows a slidable coaxial line support with locking pin.

FIG. 17 shows a slidable coaxial line support with locking clip.

FIG. 18 shows the previous embodiment in a sectional view.

FIG. 19 shows an embodiment with non-circular inner conductor.

FIG. 20 shows transmission line characteristics of line from prior art.

FIG. 21 shows transmission line characteristics of an embodiment.

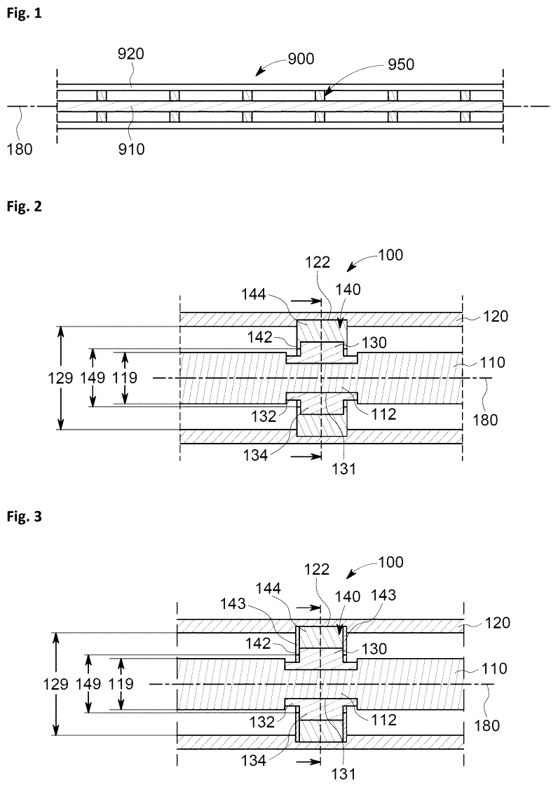

FIG. 1 shows a basic coaxial line 900. The coaxial line includes a circular inner conductor 910 enclosed by a circular outer conductor 920. Both conductors are coaxial to a center axis 180. To keep the circular inner conductor 910 in a relative position to the circular outer conductor 920, a plurality of supports 950 is provided. The supports may include at least one dielectric, insulating material. The remaining space between the circular inner conductor 910 and the circular outer conductor 920 may be filled with a gas, e.g. air, or a dielectric liquid, e.g. oil, to maintain insulation between the circular inner conductor 910 and the circular outer conductor 920.

FIG. 2 shows a first embodiment of a coaxial line support 100 mounted to a coaxial line. The coaxial line including an inner conductor 110 and an outer conductor 120, both conductors arranged coaxially and symmetrical around a center axis 180. The coaxial line support 100 includes an inner insulating section 130 and an outer conductive section 140. The coaxial line support 100 may be held at a reduced diameter section 112 of inner conductor 110 and/or in a recess 122 of outer conductor 120. The reduced diameter section and the recess are not necessary, but they provide enhanced stability and precise positioning.

The inner insulating section 130 may provide a passage for the inner conductor which may be an inner bore 131. Further, it may provide at least one axial spacer to maintain the inner conductor 110 in a defined axial position relative to the coaxial line support. Further, the inner insulating section 130 includes a radial spacer 134, defining a radial relationship or spacing between the inner conductor and the outer conductive section 140. Generally, the inner insulating section may be a ring-shaped part including a dielectric or insulating material.

The outer conductive section 140 may include a radial spacer 144 or body, which may further include at least one integral sidewall 142 for interfacing with the inner insulating section 130 and keeping a defined spatial relationship. The radial spacer or body 144 may be in electrical and mechanical contact with the outer conductor 120. Therefore, the outer conductive section 140 is restricting the inner diameter 129 of the outer conductor of the coaxial line to the inner diameter 149 of the outer conductive section. This results in a significantly higher cut-off frequency of the coaxial line and therefore allows transmission of higher frequencies in a TEM mode. The inner diameter 149 of the outer conductive section may only slightly be larger than the diameter 119 of the inner conductor. It may even be smaller when penetrating into the reduced diameter section 112.

FIG. 3 shows a modified embodiment, where the integral sidewall 142 of radial spacer 144 is replaced by at least one disc shaped sidewall 143 as a separate part. Here, the radial spacer 144 and/or at least one of the disc shaped sidewalls 143 includes a conductive material, e.g., metal, whereas the other parts may include dielectric material(s). At least one conductive part is required to stop unwanted modes.

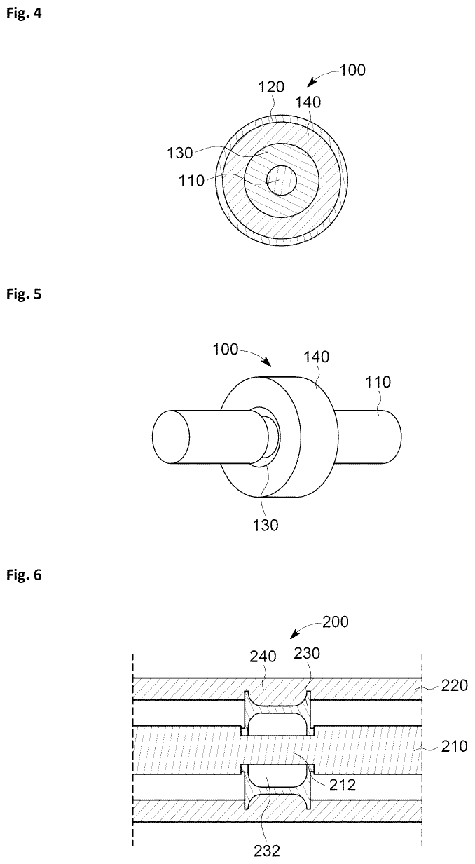

FIG. 4 shows a cross-section of the first embodiment, cut through the center of the coaxial line support 100. Here, the spatial relationship of the inner conductor 110 at the center, surrounded by inner insulating section 130 and outer conductive section 140 are shown within the outer conductor 120.

FIG. 5 shows a coaxial line support 100 on an inner conductor 110. The inner conductor 110 bears inner insulating section 130 and outer conductive section 140.

FIG. 6 shows another embodiment of a coaxial line support 200 within a coaxial line including inner conductor 210 and outer conductor 220. An inner insulating section 230 having a circular shape is configured to hold the inner conductor 210 in a defined spatial relationship to the outer conductor 220. It may be configured to be located on a reduced diameter section 212 of the inner conductor. It may further provide a hollow space 232 close to the inner conductor 210. There may be at least one extension in axial direction of the inner conductor within the reduced diameter section 212. It may further match to an outer conductive section 240 which may be part of outer conductor 220. In this embodiment, the outer conductive section is part of the outer conductor 220 and is not a separated part as in the previous embodiment. The outer conductive section 240 penetrates into the space between the outer conductor 220 and the inner conductor 210, restricting the outer conductor inner diameter and therefore increasing the cut-off frequency.

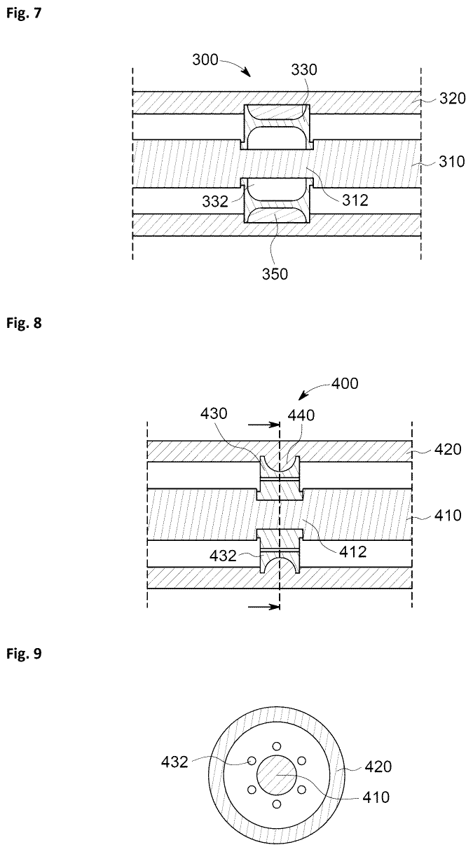

FIG. 7 shows a third embodiment in a sectional view. This embodiment basically is comparable to the previous embodiment. The main difference lies in that there is an outer absorbing section 350 close to the outer conductor 320 and therefore restricting the inner diameter of the outer conductor. The difference lies in the material of the outer absorbing section which includes an absorbing material providing an attenuation for unwanted modes. Instead of the absorbing section, there may be a conductive material, a material with conductive surface, a dielectric material or an air-filled void. Further, the third embodiment 300 includes an inner conductor 310 having a reduced diameter section 312, an outer conductor 320 and an inner insulating section 330 which may also have a hollow space 332.

In FIG. 8, a fourth embodiment is shown in a sectional view. This embodiment is similar to the second embodiment with a difference that additional through-holes 432 are provided. Basically, the fourth embodiment 400 provides an inner conductor 410 having a reduced diameter section 412 and an outer conductor 420. An inner insulating section 430 of the coaxial line support may include through-holes 432 in an axial direction, e.g. parallel to the center axis. An outer conductive section 440 may be part of the outer conductor 420.

FIG. 9 shows a cross-section of the fourth embodiment in which the through-holes are depicted. There may be any number of through-holes including two and more. In this embodiment, six through-holes are shown. The through-holes may have a diameter smaller than the distance between the outer conductor 420 and the inner conductor 410.

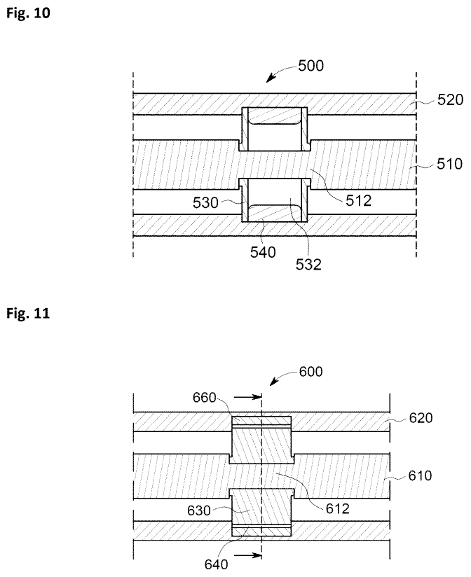

FIG. 10 shows a fifth embodiment in a sectional view. The coaxial line support 500 includes at least one insulating section, preferably two or more insulating sections 530. The insulating sections may have a disc shape with an inner radius adapted to match to a reduced diameter section 512 of inner conductor 510 and an outer diameter matching to outer conductor 520 or a recess in the outer conductor 520. In this embodiment, two inner insulating sections 530 are shown with an outer conductive section 540 in between. This outer conductive section 540 is in contact with the outer conductor 520 or part thereof and penetrates into the space between the outer conductor 520 and the inner conductor 510. There remains a hollow space 532 between the outer conductive section 540 and the inner conductor 510.

FIG. 11 shows a sixth embodiment in a sectional view. The coaxial line support 600 includes at least one insulating section, preferably two or more insulating sections 630. The insulating sections may have a disc shape with an inner radius adapted to match to a reduced diameter section 612 of inner conductor 610 and an outer diameter matching to outer conductor 620 or a recess in the outer conductor 620. In this embodiment, an outer conductive section 640, which may be a metal layer or a tube is at the outside of the at least one insulating section 630. This outer conductive section 640 is further radially enclosed by an absorber 660, which may have a ring shape. There may be at least one and preferably at least three coupling holes or channels 670 (shown in the next figure) through the outer conductive section 640. These may provide electromagnetic coupling between the at least one insulating section 630 and the absorber 660. The absorber 660 may include multiple sections which may be arranged in close proximity to the coupling holes or channels 670.

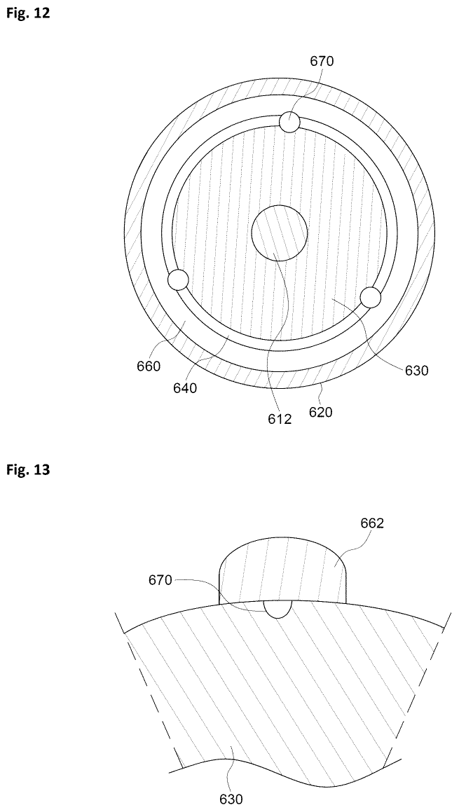

FIG. 12 shows the sixth embodiment in a further sectional view. Here the coupling holes or channels 670 through the outer conductive section 640 can be seen.

FIG. 13 shows a specific embodiment of an absorber section 662 arranged at a coupling hole or channels 670. Arranging the absorber 662 close to the coupling holes helps to save absorber material.

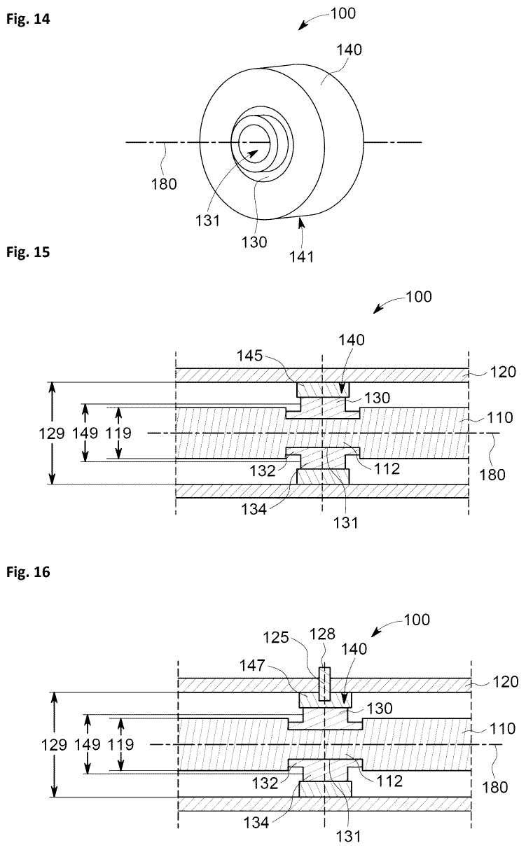

In FIG. 14, a coaxial line support 100 is shown in more detail. Basically, it may have a cylindrical shape around a center axis 180. The outer conductive section 140 may have outer circular sidewalls 141. The inner insulating section 130 may have an inner passage or bore 131.

In FIG. 15, a similar embodiment as in FIG. 2 is shown. Here, the coaxial line support 100 fits into the inner diameter 129 of outer conductor 120, such that it is slidable along the center axis 180. This allows a simplified assembly. This may be achieved by the body or radial spacer 145 having an outer diameter matching (e.g. being smaller or equal than) the inner diameter 129 of outer conductor 120. For better slidability, at least one of the sidewalls may be omitted. Having one sidewall would allow to slide the supports into the outer conductor, while providing some movement at least into one direction. Any one or both of the matching diameter and the omitted sidewalls may be applied to a coaxial line support.

FIG. 16 shows a slidable coaxial line support with a locking pin or screw 128 protruding through a locking opening, which may be a hole 125 in the outer conductor 120 into a recess of the body 147 which may include a hole for a pin. This may block a rotation of the coaxial line support together with blocking sliding along center axis 180. The hole in the outer conductor may also serve as a channel for injecting plastic material which may form at least part of a spacer.

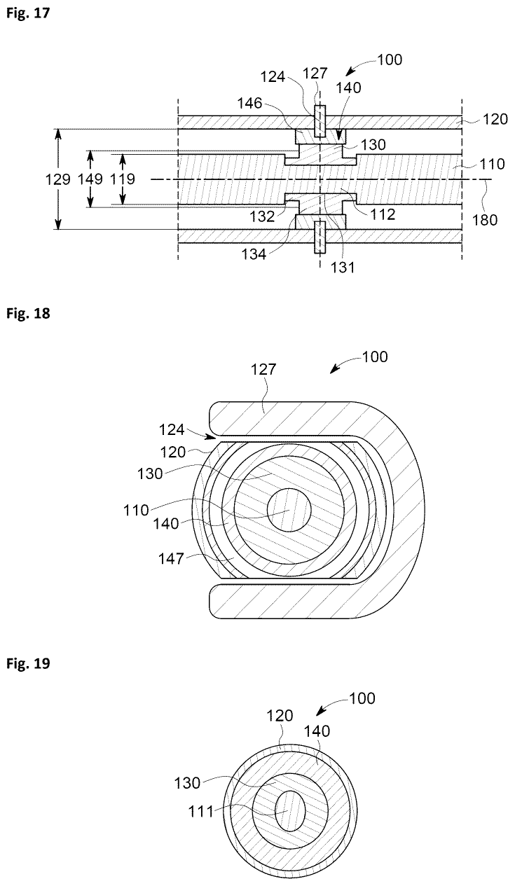

FIG. 17 shows a coaxial line support with a locking clip 127 protruding through a locking opening, which may be a slot 124 in the outer conductor 120 into a recess of the body 146 which may include at least one slot, which may be a radial or tangential slot. This may allow a rotation of the coaxial line support while blocking sliding along center axis 180.

FIG. 18 shows a cross-section of the previous embodiment, cut through the center of the coaxial line support 100. Here, the spatial relationship of the inner conductor 110 at the center, surrounded by inner insulating section 130 and outer conductive section 140 are shown within the outer conductor 120. The clip 127 may at least partially surround the outer conductor and protrudes through tangential slots 124 in the outer conductor 120 into a circular recess 148 of the body 146.

FIG. 19 shows an embodiment with a non-circular inner conductor 111 in a sectional view. Here, the inner conductor 111 may have a non-circular, e.g., elliptic shape matching to the support configured to prevent rotation of the inner insulating section 130 relative to the inner conductor 111. The inner conductor may have any other non-rotational symmetric shape e.g., a square, rectangular or triangular shape.

FIG. 20 shows s-parameters (scattering parameters) of a transmission line as known from prior art. The horizontal axis shows frequencies from 0 to 200 GHz. The vertical axis has a scale from −140 dB to 0 dB. The straight black curve shows S11 which is the input port voltage reflection coefficient. For lower frequencies the curve is almost in a range between −40 dB and −80 dB. For frequencies around the cutoff frequency, which is approximately at 185 GHz, S11 reaches up to −10 dB. At the same frequency, the curve of S21, which is the forward voltage gain has a small dip to −5 dB. At all other frequencies, it stays close to 0 dB. For better identification, the peak and the dip are encircled.

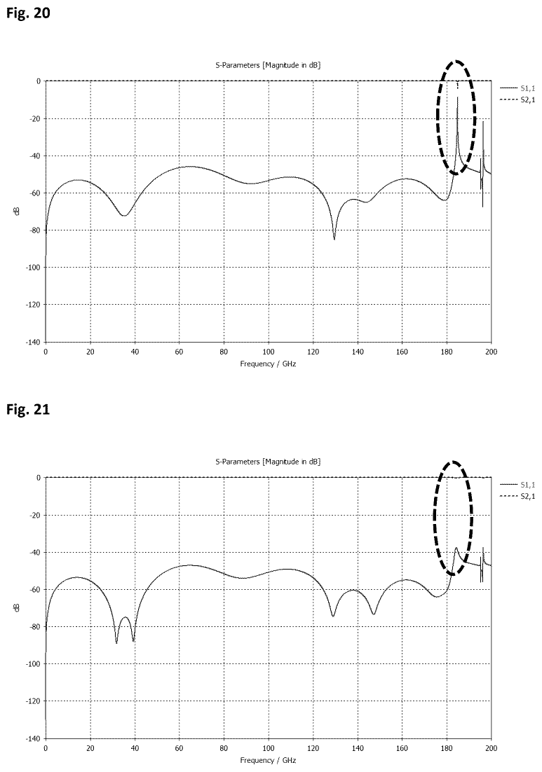

FIG. 21 shows s-parameters of a transmission line according to an embodiment, e.g., as shown in FIG. 9. The diagram has the same scaling as in the figure above. The main difference is that in S11 around 185 GHz a much lower peak reaching up to about −40 dB is shown. There is no noticeable dip in S21, which permanently stays close to 0 dB. The peak and the corresponding section of the S21 curve are encircled.

### LIST OF REFERENCE NUMERALS

100 first embodiment coaxial line support
110 inner conductor
111 non-circular inner conductor
112 reduced diameter section
119 inner conductor diameter
120 outer conductor
122 recess
124 locking slot
125 locking hole
127 locking clip
128 locking pin
129 outer conductor inner diameter
130 inner insulating section
131 inner bore (passage)
132 axial spacer
134 radial spacer
140 outer conductive section
141 outer circular sidewalls
142 integral sidewall
143 separate sidewall
144 body or radial spacer
145 slidable body or radial spacer
146 body with radial groove
147 body with hole for pin
148 recess
149 outer conductive section inner diameter
180 center axis
200 second embodiment coaxial line support
210 inner conductor
212 reduced diameter section
220 outer conductor
230 inner insulating section
232 hollow space
240 outer conductive section
300 third embodiment coaxial line support
310 inner conductor
312 reduced diameter section
320 outer conductor
330 inner insulating section
332 hollow space
350 outer absorbing section
400 fourth embodiment coaxial line support
410 inner conductor
412 reduced diameter section
420 outer conductor
430 inner insulating section
432 through holes
440 outer conductive section
500 fifth embodiment coaxial line support
510 inner conductor
512 reduced diameter section
520 outer conductor
530 inner insulating section
532 hollow space
540 outer conductive section
600 sixth embodiment coaxial line support
610 inner conductor
612 reduced diameter section
620 outer conductor
630 inner insulating section
640 outer conductive section / metal layer
660 absorber
670 coupling through hole
910 circular inner conductor
920 circular outer conductor
950 support

1. A coaxial line support comprising
an inner bore at a center axis and an outer circular contour symmetrically to the center axis,
the coaxial line support comprising an inner insulating section at the inner bore and an outer conductive section radially around the inner insulating section,
wherein the inner bore is configured for holding a uninterrupted inner conductor of a coaxial line and the outer circular contour is configured to be held at the inner side of an outer conductor of the coaxial line, or
wherein the coaxial line support is configured for holding a uninterrupted inner conductor of a coaxial line centered within the coaxial line.

2. A coaxial line support according to claim 1, including an electrically absorbing material.

3. A coaxial line support according to claim 1, characterized in, that
the outer conductive section comprises a radial metal layer.

4. A coaxial line support according to claim 1,
characterized in, that
the outer conductive section includes at least one coupling hole through the outer conductive section and an absorber radially outside of the at least one coupling hole.

5. A coaxial line including at least one coaxial line support according to claim 1,
characterized in, that
the at least one coaxial line comprises an uninterrupted circular inner conductor and a circular outer conductor, the circular outer conductor being arranged radially outside of the uninterrupted circular inner conductor and spaced therefrom by an airgap, wherein the coaxial line support is arranged between the uninterrupted circular inner conductor and the circular outer conductor while at least mechanically contacting the uninterrupted circular inner conductor and the circular outer conductor.

6. A coaxial line according to claim 5,
characterized in, that
a plurality of coaxial line supports is provided spaced equally from each other.

7. A coaxial line according to claim 5
characterized in, that
the outer conductive section is electrically connected to the circular outer conductor (920).

8. A coaxial line according to claim 7,
characterized in, that
the outer conductive section (140) is part of the circular outer conductor.

9. A coaxial line according to claim 5
characterized in, that
an inner diameter of the outer conductive section is smaller than an inner diameter of the circular outer conductor.

10. A coaxial line according to claim 5,
characterized in, that
the at least one coaxial line support fits into an inner diameter of the outer conductor to be slidable along the center axis.

11. A coaxial line according to claim 10,
characterized in, that
a locking means protrudes through a locking opening (124, 125) in the outer conductor into a recess of the coaxial line support.

12. A coaxial line according to claim 5,
further comprising a non-circular inner conductor that has a non-circular shape matching the at least one coaxial line support and configured to prevent relative rotation of the non-circular inner conductor with respect to the at least one coaxial line support.

13. A coaxial line (900) according to claim 5,
wherein the circular outer conductor comprises at least one hole or opening configured for injecting a plastic material for locking the at least one coaxial line support mechanically.

14. A coaxial line according to claim 5,
wherein the at least one coaxial line support is a resonator having a resonance frequency above or equal to a cutoff frequency of the coaxial line.
